(19) United States
(12) Patent Application Publication
(10) Pub. No.: US 2016/0109280 A1
(43) Pub. Date: Apr. 21, 2016

(54) SMART AIRCRAFT OVERHEAD LUGGAGE BIN SYSTEM

(71) Applicant: The Boeing Company, Chicago, IL (US)

(72) Inventors: Jessica C. Tiu, Kirkland, WA (US); Jessica D. Port, Seattle, WA (US); Anil A. Mohammed, Mill Creek, WA (US); Bethany Voss, Edmonds, WA (US)

(21) Appl. No.: 14/515,328

(22) Filed: Oct. 15, 2014

(51) Int. Cl. G01G 19/08; B64D 11/00

(52) U.S. Cl. CPC G01G 19/08; B64D 11/003

(57) ABSTRACT

A system is disclosed for displaying storage capacity status information for one or more passenger storage bins in an aircraft. Load sensors are coupled to each passenger storage bin and provide an output signal proportional to a weight of items within the bin. Range sensors are also coupled to each passenger storage bin and provide an output signal proportional to an amount of empty space available within the bin. A processor is coupled to the associated load sensors and range sensors and calculates, based upon the output signals from the load sensors and the range sensors, whether the associated storage bin is filled to capacity. The processor is also coupled to a display device to provide a status signal. The display device provides a visual indication based upon such status signal whether or not the associated storage bin is filled to capacity.

### FIELD

This disclosure relates generally to a smart overhead luggage bin system for use in an aircraft.

### BACKGROUND

Airplane turn time—the time required to unload an airplane after its arrival at the gate and to prepare it for departure again—has increased since the mid-1970s. This contributes to both flight delays and increased passenger frustration. One of the key elements of turn time in a single-aisle aircraft is passenger boarding. One factor that contributes to an increase in passenger boarding time is an increase in the amount of passenger carry-on luggage. Passengers have increased their carry-on baggage for a number of reasons, including the implementation of checked baggage fees by the airlines. During the boarding process, finding available overhead bin storage space for carry-on baggage becomes increasingly time consuming and frustrating for passengers and flight attendants, and can cause delayed departure.

Airlines and aircraft manufacturers have attempted to address boarding delays in a number of ways. For example, airlines have modified the order of passenger boarding, but studies have shown that new boarding algorithms have proven largely ineffective in reducing boarding time. Airlines and manufacturers have also changed the size and shape of overhead bin storage space to make the space more usable, but because this option is limited by space constraints this has also been found ineffective in reducing boarding time.

Accordingly, there is a need for an improved system which assists in speeding the aircraft boarding process.

### SUMMARY

In one aspect, a system is provided for displaying storage capacity status information for one or more passenger storage bins in an aircraft. The system includes at least one first sensor coupled to each of the passenger storage bins for providing a first output signal proportional to a first type of capacity level of the associated passenger storage bin. The system also includes a processor for each of the passenger storage bins coupled to the associated at least one first sensor and configured to calculate, based upon the output signal from the at least one first sensor, whether or not the associated storage bin is filled to capacity. The processor is also configured to provide an output signal indicating whether or not the associated storage bin is filled to capacity. Finally, the system includes a display device for each passenger storage bin coupled to receive the output signal from the associated processor and for providing a visual indication whether or not the associated storage bin is filled to capacity.

In one further aspect, each of the at least one first sensors may be a load sensor and the output signal from each of the at least one first sensors may be proportional to a weight of items within the associated passenger storage bin.

In another further aspect, each of the at least one first sensors may be a range sensor and the output signal from each of the at least one first sensors may be proportional to an amount of empty space available within the associated passenger storage bin.

In yet another further aspect, the system may also include at least one second sensor coupled to each of the passenger storage bins for providing an output signal proportional to a second type of capacity level of the associated passenger storage bin. The processor may also be coupled to the associated at least one second sensor and may be further configured to calculate whether or not the associated storage bin is filled to capacity based on the output signals from the at least one first sensor and the at least one second sensor. Each of the at least one first sensors may be a load sensor and the output signal from each of the at least one first sensors may be proportional to a weight of items within the associated passenger storage bin. Each of the at least one second sensors may be a range sensor and the output signal from each of the at least one second sensors may be proportional to an amount of empty space available within the associated passenger storage bin.

Each processor may be configured to calculate whether or not the associated storage bin is filled to capacity based, at least in part, on a predetermined weight level. In addition, each processor may be configured to calculate whether or not the associated storage bin is filled to capacity based, at least in part, on a predetermined amount of empty space.

The system may also include an attendant console coupled to each of the processors for the one or more passenger storage bins for receiving and displaying the storage capacity status of each of the one or more passenger storage bins. Also, each of the processors for the one or more passenger storage bins may be coupled to each other via a network and the system may also include a wireless interface coupled to the network and a handheld wireless device coupled to the wireless interface for receiving, via the wireless interface, and displaying the storage capacity status of each of the one or more passenger storage bins.

Each of the display devices may be a light emitting element or a display panel located on an external portion of or adjacent to the associated passenger storage bin. Each of the at least one load sensors may be coupled to a support structure of the associated passenger storage bin to measure load of the associated storage bin or may be mounted on a bottom panel of the associated passenger storage bin to measure load of the associated storage bin.

In another aspect, a system is provided for displaying storage capacity status information for one or more passenger storage bins in an aircraft. The system includes at least one first sensor coupled to each of the passenger storage bins for providing a first output signal proportional to a first type of capacity level of the associated passenger storage bin. The system also includes a processor coupled to each of the at least one first sensors and configured to calculate, for each of the at least one first sensors and based upon the output signal from the at least one first sensor, whether or not the storage bin associated with the at least one first sensor is filled to capacity. The processor is also configured to provide an output signal for each of the at least one first sensors indicating whether or not the storage bin associated with the at least one first sensor is filled to capacity. Finally, the system includes a display device for each passenger storage bin coupled to receive the output signal from the processor and for providing a visual indication whether or not the associated passenger storage bin is filled to capacity.

In one further aspect, each of the at least one first sensors may be a load sensor and the first output signal from each of the at least one first sensors may be proportional to a weight of items within the associated passenger storage bin.

In another further aspect, each of the at least one first sensors may be a range sensor and the first output signal from each of the at least one first sensors may be proportional to an amount of empty space available within the associated passenger storage bin.

In yet another further aspect, the system may also include at least one second sensor coupled to each of the passenger storage bins for providing an output signal proportional to a second type of capacity level of the associated passenger storage bin. The processor may also be coupled to each of the at least one second sensors and may be further configured to calculate whether or not the storage bin associated with each of the at least one second sensors is filled to capacity based on the output signals from the at least one first sensor and the at least one second sensor. Each of the at least one first sensors may be a load sensor and the output signal from each of the at least one first sensors may be proportional to a weight of items within the associated passenger storage bin. Each of the at least one second sensors may be a range sensor and the output signal from each of the at least one second sensors may be proportional to an amount of empty space available within the associated passenger storage bin.

An attendant console may be coupled to the processor for receiving and displaying the storage capacity status of each of the one or more passenger storage bins.

In yet another aspect, a method for displaying storage capacity status information for one or more passenger storage bins in an aircraft. First, for each of the passenger storage bins, a weight of items within the associated passenger storage bin is determined. Next, for each of the passenger storage bins, an amount of empty space available within the associated passenger storage bin is determined. Then, based upon the weight of items within the associated passenger storage bin and the amount of empty space available within the associated passenger storage bin, a processor calculates whether or not the associated storage bin is filled to capacity. Finally, based upon the calculation by the processor, a visual indication is provided indicating whether or not the associated storage bin is filled to capacity.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is block circuit diagram of an overhead luggage storage bin capacity sensing system according to a first embodiment of the present disclosure;

FIG. 2 is a diagram showing load sensors positioned on a bottom surface of an overhead luggage storage bin according to the present disclosure;

FIG. 3 is a diagram showing range sensors positioned on a top surface of an overhead luggage storage bin according to the present disclosure;

FIG. 4A is a diagram showing visual indicators according to the present disclosure positioned on a front surface of overhead luggage storage bins, and FIG. 4B is a diagram showing a close-up of a single visual indicator from FIG. 4A;

FIG. 5 is block circuit diagram of an overhead luggage storage bin capacity sensing system according to a second embodiment of the present disclosure; and

FIG. 6 is a flowchart of a method of determining overhead luggage storage bin capacity according to the present disclosure.

### DETAILED DESCRIPTION

In the present disclosure, like reference numbers refer to like elements throughout the drawings, which illustrate various exemplary embodiments of the present disclosure.

The system disclosed herein helps to speed the boarding process by providing a clear visual indication of whether there is available space in each overhead luggage storage bin. Preferably, such indication is visible from a distance even if the overhead luggage storage bin is closed. With this system, passengers may proceed down an aircraft aisle quickly to an available bin, without having to open each closed bin to check for available space. The system disclosed herein allows passengers to easily identify and fill overhead luggage storage bins only partially filled but closed by other passengers. The present system eases the frustrating and time-consuming search for overhead space that occurs when other passengers close partially filled overhead luggage storage bins, and thus speeds the boarding process and provides a smoother and less stressful boarding experience for both flight attendants and passengers. In addition, when passengers spend less time searching for storage space and instead are able to move directly to an empty bin, there is less interference (and resultant passenger stress) in the aisles. A quicker boarding process is also instrumental in improving an airline's on-time performance.

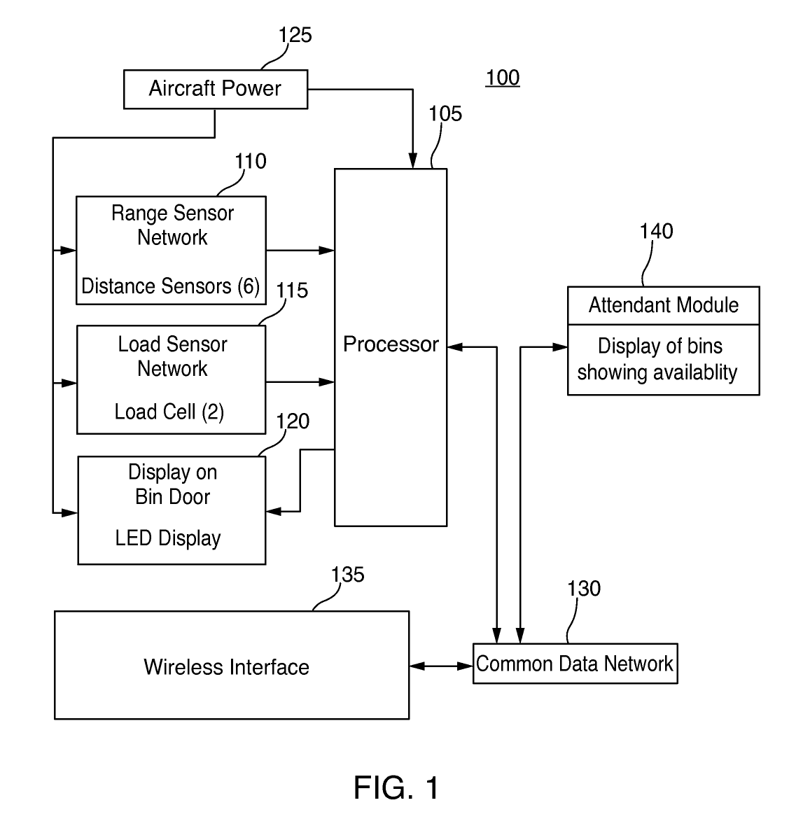

Referring now to FIG. 1, a block diagram is shown for an overhead luggage storage bin capacity sensing system 100 according to a first embodiment. Sensing system 100 includes, for each overhead luggage storage bin, a processor 105 having a first input coupled to a range sensor network 110 and a second input coupled to a load sensor network 115. In addition, processor 105 may have an output coupled to a display device 120 which is preferably mounted on an external portion of a door of the overhead luggage storage bin. As one of ordinary skill in the art will readily recognize, display device 120 may be mounted in other positions adjacent to the associated overhead luggage storage bin and still provide adequate status notice to passengers. Processor 105, range sensor network 110, load sensor network 115 and display device 120 are all powered via the aircraft power system 125, which in one embodiment provides power at 12 volt DC. In addition, processor 105 and the sensors selected for use in range sensor network 110 and load sensor network 115 are preferably selected to be low power, low voltage units to minimize the loading on aircraft power system 125. Display device 120 is preferably an LED device which provides a clear indication that the associated overhead luggage storage bin is either “filled” or “not filled.” For example, display device 120 may emit a first color (e.g., green) when the associated overhead luggage storage bin is not filled and a second color (e.g., red) when the overhead luggage storage bin is filled. In one alternative embodiment, display device 120 may only become active (lit) when the associated overhead luggage storage bin is filled (or when it is not filled)—e.g., an LED device positioned behind a translucent “FILLED” (or “NOT FILLED”) panel. In another alternative embodiment, display device 120 may be an LED display which provides more detailed description of the status of the associated overhead luggage storage bin, e.g., a display which states one of “FILLED” or “NOT FILLED.”

The processor 105 for each overhead luggage storage bin may be coupled to a wireless interface 135 (discussed below) and/or one or more display consoles 140 via a common data network 130. The display console 140 displays the status of each overhead luggage storage bin on the aircraft. Display console 140 may be provided for access only by the flight attendants, or may be publicly located at the entrance of the aircraft so that entering passengers can immediately access the status of each overhead luggage storage bin. In a further embodiment, more than one display consoles 140 may be provided, e.g., one for use by flight attendants and the other for use by entering passengers. Data network 120 may be, for example, an aircraft data network compliant with industry standard ARINC-664 network protocol. Since aircraft data network drops are already available in new aircraft for passenger services units and oxygen boxes, the additional wiring necessary to interface each processor 105 to the aircraft data network is minimal. In another embodiment, groups of processors 105 may be daisy-chained together, with each processor 105 linked to processors 105 in adjacent overhead luggage storage bins. In this embodiment, only one processor 105 among the group of processors is linked to the aircraft data network 130. This allows for a reduced number of interfaces to the aircraft data network 130, a reduced complexity, and a streamlined design and easier installation. This also decreases the overall system weight and cost of additional wiring by keeping the system self-contained.

As described above, in the present system each overhead luggage storage bin includes a range sensor network 110 and a load sensor network 115, each network 110, 115 coupled to an input of a processor 105, preferably an on-board microcontroller. Processor 105 is configure to receive signals from each range sensor within range sensor network 110 and signals from each load sensor in load sensor network 115 and, based on such signals, to determine if the associated overhead luggage storage bin has mass or volume capacity available (i.e., if it is filled, either by weight or volume). Based on such determination, processor 105 is configured to output a signal to display device 120 that indicates current status information, i.e., at least whether the particular overhead luggage storage bin is either “FILLED” or “NOT FILLED,” as discussed above. Processor 105 is also configured to communicate that status information to a display console 140 via the aircraft data network 130. In a further embodiment, a wireless interface 135 (e.g., a Bluetooth® interface) may be provided coupled to the aircraft data network 130 for transmitting signals to a flight attendant's wireless device (e.g., a smart phone with a Bluetooth® interface and associated specialized application) to allow each flight attendant to access status information throughout the aircraft. In other embodiments, satisfactory operation may be obtained by using only a range sensor network 110 or only a load sensor network 115 to determine if full capacity of each respective overhead luggage storage bin has been reached.

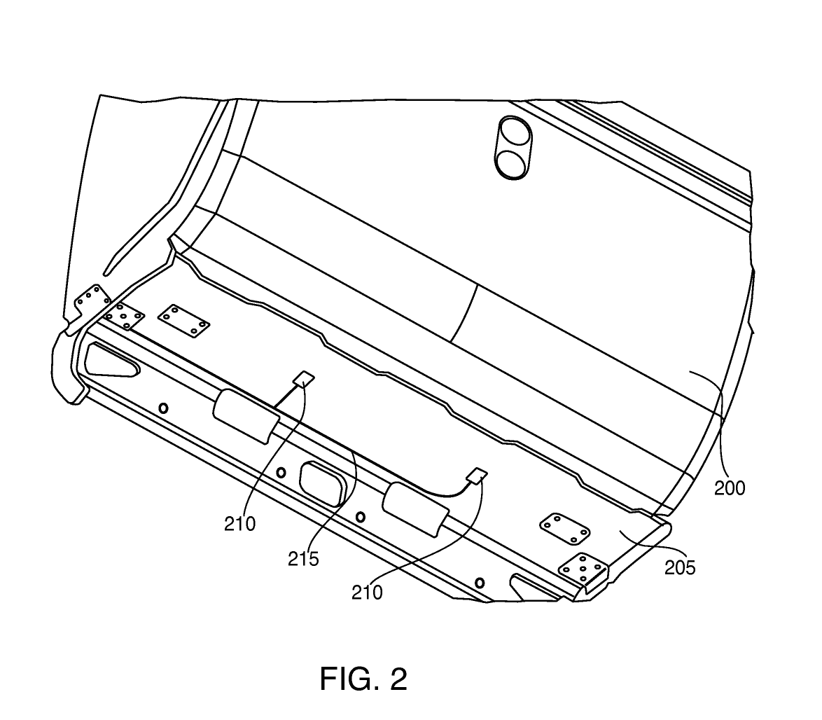

Referring now to FIG. 2, each load sensor 210 in the load sensor network 115 of FIG. 1 is preferably mounted on a bottom panel 205 of the overhead luggage storage bin 200. Each load sensor 210 is preferably a conventional load cell (or equivalent as known to one of ordinary skill in the art). Each load sensor 201 is coupled to processor 105 (not shown in FIG. 2) via wiring 215. In alternative embodiments, load sensors 210 may be mounted either on support rods or attachment fittings for overhead luggage storage bin 200 (instead of on bottom panel 205). Each load sensor 210 provides an output signal which enable processor 105 to determine, based upon predetermined settings, if a maximum weight for overhead luggage storage bin 200 has been met by the luggage or other items currently stored in that bin 200 (meaning that nothing further should be placed into overhead luggage storage bin 200). Two load sensors 210 are shown in FIG. 2 for the load sensor network 115 of FIG. 1, but, in an alternative embodiment, additional load sensors 210 may be included, and satisfactory results may be obtained in some cases with only one load sensor 210.

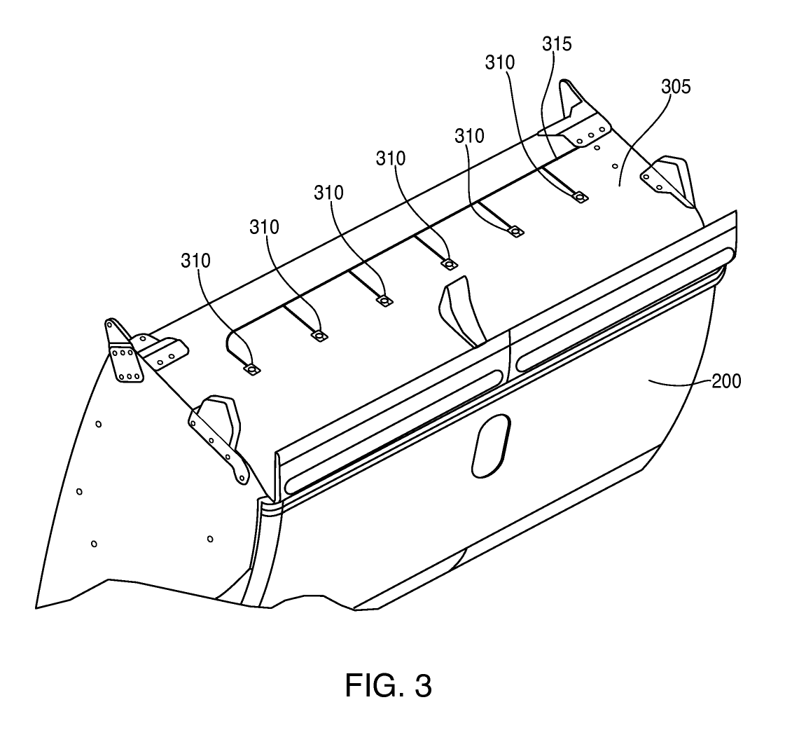

Referring now to FIG. 3, range sensor network 110 of FIG. 1 preferably consists of six ultrasonic rangefinder devices 310 mounted on a top panel 305 of overhead luggage storage bin 200 that are used in system 100 to determine available volume (space) within overhead luggage storage bin 200. Each of the ultrasonic rangefinder devices 310 provides a volume signal to processor 105 (not shown in FIG. 3) via wiring 315 to allow processor 105 to generate a map of the current volume of stowed luggage within overhead luggage storage bin 200 to determine, based on predetermined settings, whether there is any space remaining within overhead luggage storage bin 200. In FIG. 3, six ultrasonic rangefinder devices 310 are shown in range sensor network 110. As one of ordinary skill in the art will readily recognize, the precise number of such devices 310 required in range sensor network 110 depends upon the size of overhead luggage storage bin 200 and the type of such device 310 selected for use in system 100.

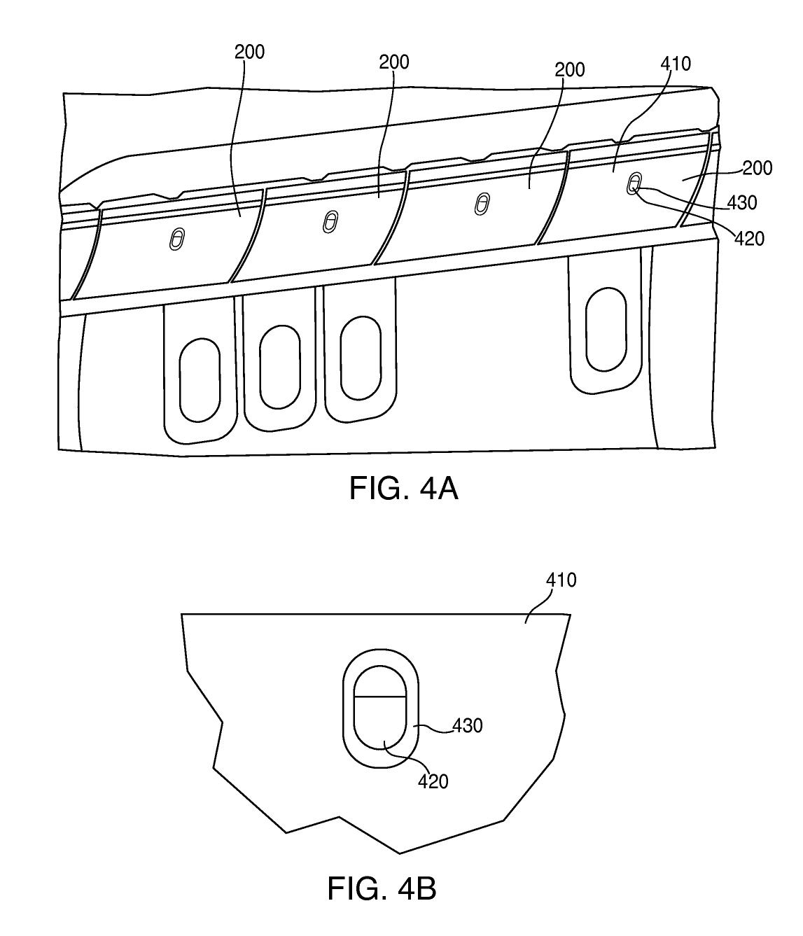

Referring now to FIGS. 4A and 4B, each overhead luggage storage bin 200 has a front panel 410 with a latch mechanism 420. A display device 430 may be provided surrounding latch mechanism 420 which is, in the preferred embodiment, capable of being activated in two different colors, e.g., red and green. In operation, processor 105 is configured to determine, preferably based on both the received load data and the received volume data, whether or not the associated overhead luggage storage bin 200 has space available for additional luggage, and provides a status indication (i.e., causes display device 430 to be activated as a red light when overhead luggage storage bin 200 is filled and to be activated as a green light when overhead luggage storage bin 200 is not filled). As discussed above and as one of ordinary skill in the art will readily recognize, there are many ways to display status and all are intended to fall within the scope of the present disclosure. In a further embodiment, as discussed above, status information for each overhead luggage storage bin 200 may also be transmitted to display console 140.

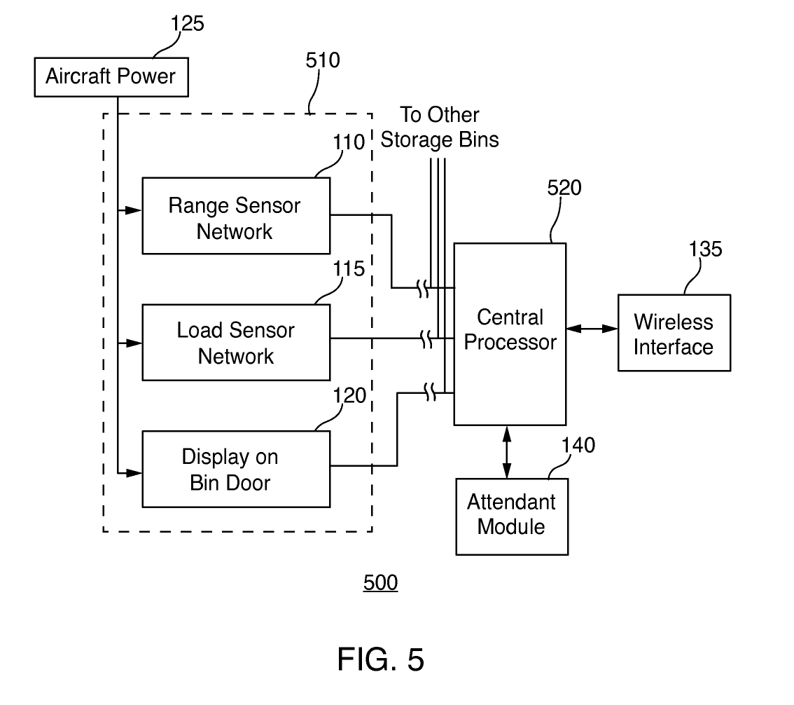

Referring now to FIG. 5, a block diagram is shown for an overhead luggage storage bin capacity sensing system 500 according to a second embodiment. Sensing system 500 includes, for each overhead luggage storage bin (one storage bin is represented by dotted line 510), a range sensor network 110, a load sensor network 115 and a display device 120. Sensing system 500 also includes a central processor 520 which is electrically coupled in a conventional manner to the range sensor network 110, load sensor network 115 and display device 120 for each overhead luggage storage bin. Central processor 520 is also conventionally coupled to attendant module 140 and to a wireless interface 135. Sensing system 500 operates in a similar manner to sensing system 100 of the first embodiment shown in FIG. 1, but with central processor 520 performing the processing for each overhead luggage storage bin (instead of having separate processors 105 for each storage bin as in the FIG. 1 embodiment).

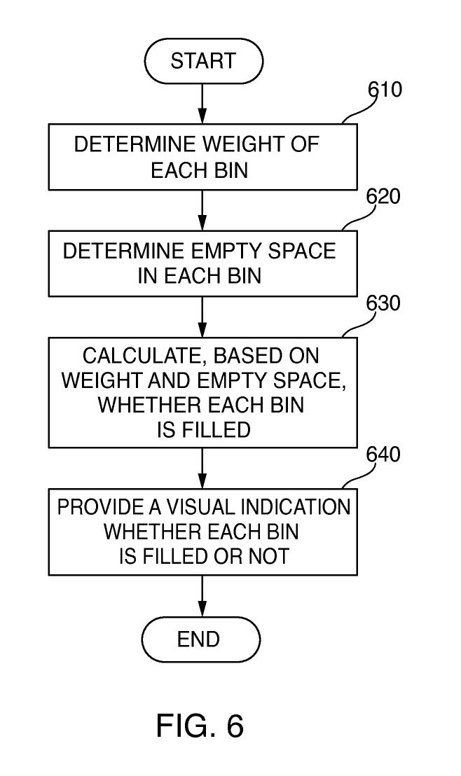

Referring now to FIG. 6, a flowchart 600 is shown of a method for displaying storage capacity status information for one or more passenger storage bins in an aircraft. First, at step 610, the weight of items within the associated passenger storage bin is determined for each of the passenger storage bins. Next, at step 620, an amount of empty space available within the associated passenger storage bin is determined for each of the passenger storage bins. Thereafter, at step 630, a calculation is made based upon the weight of items within the associated passenger storage bin and the amount of empty space available within the associated passenger storage bin, whether or not the associated storage bin is filled to capacity for each of the passenger storage bins. Finally, at step 640, a visual indication is provided indicating whether or not the associated storage bin is filled to capacity for each of the passenger storage bins.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system for displaying storage capacity status information for one or more passenger storage bins in an aircraft, comprising:
at least one first sensor coupled to each of the passenger storage bins for providing a first output signal proportional to a first type of capacity level of the associated passenger storage bin;
a processor for each of the passenger storage bins coupled to the associated at least one first sensor and configured to calculate, based upon the output signal from the at least one first sensor, whether or not the associated storage bin is filled to capacity, the processor also configured to provide an output signal indicating whether or not the associated storage bin is filled to capacity; and
a display device for each passenger storage bin coupled to receive the output signal from the associated processor and for providing a visual indication whether or not the associated storage bin is filled to capacity.

2. The system of claim 1, wherein each of the at least one first sensors is a load sensor and wherein the output signal from each of the at least one first sensors is proportional to a weight of items within the associated passenger storage bin.

3. The system of claim 1, wherein each of the at least one first sensors is a range sensor and wherein the output signal from each of the at least one first sensors is proportional to an amount of empty space available within the associated passenger storage bin.

4. The system of claim 1, further comprising at least one second sensor coupled to each of the passenger storage bins for providing an output signal proportional to a second type of capacity level of the associated passenger storage bin; and
wherein the processor is also coupled to the associated at least one second sensor and is further configured to calculate whether or not the associated storage bin is filled to capacity based on the output signals from the at least one first sensor and the at least one second sensor.

5. The system of claim 4, wherein each of the at least one first sensors is a load sensor and wherein the output signal from each of the at least one first sensors is proportional to a weight of items within the associated passenger storage bin; and wherein each of the at least one second sensors is a range sensor and wherein the output signal from each of the at least one second sensors is proportional to an amount of empty space available within the associated passenger storage bin.

6. The system of claim 5, wherein each processor is configured to calculate whether or not the associated storage bin is filled to capacity based, at least in part, on a predetermined weight level.

7. The system of claim 5, wherein each processor is configured to calculate whether or not the associated storage bin is filled to capacity based, at least in part, on a predetermined amount of empty space.

8. The system of claim 1, further comprising an attendant console coupled to each of the processors for the one or more passenger storage bins for receiving and displaying the storage capacity status of each of the one or more passenger storage bins.

9. The system of claim 1, wherein each of the processors for the one or more passenger storage bins is coupled to each other via a network and further comprising:
a wireless interface coupled to the network; and
a handheld wireless device coupled to the wireless interface for receiving, via the wireless interface, and displaying the storage capacity status of each of the one or more passenger storage bins.

10. The system of claim 1, wherein each of the display devices comprises a light emitting element located on an external portion of or adjacent to the associated passenger storage bin.

11. The system of claim 1, wherein each of the display devices comprises a display panel located on an external portion of or adjacent to the associated passenger storage bin.

12. The system of claim 2, wherein each of the at least one load sensors are coupled to a support structure of the associated passenger storage bin to measure load of the associated storage bin.

13. The system of claim 2, wherein each of the at least one load sensors are mounted on a bottom panel of the associated passenger storage bin to measure load of the associated storage bin.

14. A system for displaying storage capacity status information for one or more passenger storage bins in an aircraft, comprising:
at least one first sensor coupled to each of the passenger storage bins for providing a first output signal proportional to a first type of capacity level of the associated passenger storage bin;
a processor coupled to each of the at least one first sensors and configured to calculate, for each of the at least one first sensors and based upon the output signal from the at least one first sensor, whether or not the storage bin associated with the at least one first sensor is filled to capacity, the processor also configured to provide an output signal for each of the at least one first sensors indicating whether or not the storage bin associated with the at least one first sensor is filled to capacity; and
a display device for each passenger storage bin coupled to receive the output signal from the processor and for providing a visual indication whether or not the associated passenger storage bin is filled to capacity.

15. The system of claim 14, wherein each of the at least one first sensors is a load sensor and wherein the first output signal from each of the at least one first sensors is proportional to a weight of items within the associated passenger storage bin.

16. The system of claim 14, wherein each of the at least one first sensors is a range sensor and wherein the first output signal from each of the at least one first sensors is proportional to an amount of empty space available within the associated passenger storage bin.

17. The system of claim 14, further comprising at least one second sensor coupled to each of the passenger storage bins for providing an output signal proportional to a second type of capacity level of the associated passenger storage bin; and
wherein the processor is also coupled to each of the at least one second sensors and is further configured to calculate whether or not the storage bin associated with each of the at least one second sensors is filled to capacity based on the output signals from the at least one first sensor and the at least one second sensor.

18. The system of claim 17, wherein each of the at least one first sensors is a load sensor and the output signal from each of the at least one first sensors is proportional to a weight of items within the associated passenger storage bin; and wherein each of the at least one second sensors is a range sensor and the output signal from each of the at least one second sensors is proportional to an amount of empty space available within the associated passenger storage bin.

19. The system of claim 14, further comprising an attendant console coupled to the processor for receiving and displaying the storage capacity status of each of the one or more passenger storage bins.

20. A method for displaying storage capacity status information for one or more passenger storage bins in an aircraft, comprising the steps of:
determining, for each of the passenger storage bins, a weight of items within the associated passenger storage bin;
determining, for each of the passenger storage bins, an amount of empty space available within the associated passenger storage bin;
calculating, based upon the weight of items within the associated passenger storage bin and the amount of empty space available within the associated passenger storage bin, whether or not the associated storage bin is filled to capacity; and
providing, based upon the calculating step, a visual indication whether or not the associated storage bin is filled to capacity.
